(19) United States
(12) Patent Application Publication
(10) Pub. No.: US 2010/0297330 A1
(43) Pub. Date: Nov. 25, 2010

(54) YOGHURT CONTAINING HYDROXYTYROSOL AND OTHER BIOPHENOLS WITH A PREVENTIVE NUTRITIONAL ACTIVITY BENEFICIAL TO HUMAN BEINGS

(75) Inventors: Luigi Villanova, Zollino (IT); Azzurra Villanova, Zollino (IT); Luciano Villanova, Zollino (IT); Alessandro Merendino, Zollino (IT); Gianluca Fasieloo, Zollino (IT); Felicia Cisale, Zollino (IT)

Correspondence Address: YOUNG & THOMPSON, 209 Madison Street, Suite 500, Alexandria, VA, 22314, US

(73) Assignee: Lachifarma S.R.L. Laboratorio Chimico Farmaceutico Salentino, Zollino (IT)

(21) Appl. No.: 12/669,621

(22) PCT Filed: Jul. 15, 2008
(86) PCT No.: PCT/EP2008/005761

§ 371 Date: Apr. 23, 2010

(30) Foreign Application Priority Data
Jul. 19, 2007 (IT) MI 2007 A 001454

(51) Int. Cl. A23C 9/123

(52) U.S. Cl. 426/583

(57) ABSTRACT

A yoghurt includes hydroxytyrosol as an additional component, so as to provide a healthy, natural food product with additional health-giving and beneficial characteristics, which in particular provides nutritional prevention against damage caused by oxidative stress, inflammation, angiogenesis and the related tumoral processes, cholesterol proliferation and atherosclerotic processes, and a general effect of nutritional prevention of aging.

The present invention relates to a yoghurt containing hydroxytyrosol and other biophenols as an additional component.

### BACKGROUND TO THE INVENTION

Yoghurt has become a basic ingredient in the diets of the industrialised countries, due to its immunological properties associated with promotion and restoration of the normal balance of the beneficial bacterial flora in the intestine, and to its pleasant flavour and limited calorie content.

Yoghurt is traditionally prepared by fermenting milk by adding products that cause it to curdle. Other ingredients, such as whole fruit or fruit chunks, cereals and the like, are often added to the yoghurt thus obtained, known as “white” yoghurt, to give it particular characteristics of flavour, nutritional value, etc.

Hydroxytyrosol (hereinafter called “HT”) is a constituent of natural origin with a polyphenol structure which possesses an invaluable biological activity, as demonstrated in numerous publications [1] [2] [3] [4]. In particular, it has been demonstrated that HT:
effectively counteracts the cytotoxic effects of reactive oxygen species in the human cell systems [5] [6];
permeates the cell membranes by means of a passive mechanism[7];
at concentrations of 2 g/kg of body weight does not cause toxicity or evident alterations in the internal organs of mammals (unpublished proprietary studies);
retards the oxidation of Low-Density Lipoproteins (LDLs), one of the main mechanisms underlying the atherosclerotic processes [4].

It has been demonstrated that hydroxytyrosol is one of the most active antioxidants currently known [6].

Due to its dual hydrophilic and lipophilic nature, HT is stored in the cell membranes, where it performs a protective action against oxidative damage caused by free radicals.

It has been demonstrated that HT protects epithelial cell monolayers against the damage caused by hyperoxidation, which involves a reduction in cell viability and an abnormal increase in membrane permeability, leading to inflammation and oxidation of the polyunsaturated acids of the cell membranes.

The direct or indirect consequences of the protective effect against free radicals are a reduction in cardiovascular diseases (all those associated with atherosclerosis), inflammatory disorders, aging and cell degeneration, with consequent tumours.

The above-mentioned study by Manna [6] demonstrates that HT can perform its protective action at very low concentrations. In fact, HT is active in vitro at concentrations as low as 0.75 μg/ml.

A process for the preparation of hydroxytyrosol with high purity suitable for use as a component in the pharmaceutical, food and cosmetic industries is disclosed, for example, by EP1623960.

### DESCRIPTION OF THE INVENTION

One of the purposes of the present invention is to provide a yoghurt that includes HT as a beneficial additional component, so as to offer a healthy, natural food product with additional health-giving and beneficial characteristics, which in particular provides nutritional prevention against damage caused by oxidative stress, inflammation, angiogenesis processes, cholesterol proliferation, atherosclerotic processes and tumoral processes, and a general effect of nutritional prevention of aging.

The yoghurt with added HT of the invention contains HT in a stable, unaltered form, and maintains the typical organoleptic characteristics of traditional yoghurt as perceived by the consumer, at the same time presenting an antioxidant action due to the presence of HT.

Another purpose of this invention is the use of yoghurt with added HT to improve the body's resistance to oxidative stress, inflammation, angiogenesis processes, cholesterol proliferation, atherosclerotic processes and tumoral processes, and a general effect of nutritional prevention of aging.

The yoghurt according to the invention may also contain other ingredients selected from those typically added to traditional yoghurt, such as whole fruit or fruit chunks, cereals, vegetable fibres, honey, chocolate chips, flavourings, etc.

The yoghurt according to the invention is characterised by the maintenance of its organoleptic properties, HT activity and stability for at least three months.

According to the invention, HT will be added to the yoghurt in percentages ranging between 10 and 0.0001%, preferably between 0.1 and 0.01%.

### EXAMPLES OF FORMULATIONS

The following are some examples of yoghurts according to the invention, containing hydroxytyrosol with other biophenols and possibly other healthy ingredients.

### Example 1

| | (%) |
|---|---|
| Basic yoghurt | 99.69 |
| Flavouring | 0.30 |
| Hydroxytyrosol | 0.01 |
| | 100.00 |

### Example 2

| | (%) |
|---|---|
| Basic yoghurt | 94.69 |
| Dietary vegetable fibre | 5.00 |
| Flavouring | 0.30 |
| Hydroxytyrosol | 0.01 |
| | 100.00 |

### Example 3

| | (%) |
|---|---|
| Basic yoghurt | 99.67 |
| Flavouring | 0.30 |
| Hydroxytyrosol | 0.01 |
| Caffeic acid | 0.01 |
| Gallic acid | 0.01 |
| | 100.00 |

### Example 4

| | (%) |
|---|---|
| Basic yoghurt | 99.49 |
| Flavouring | 0.30 |
| Hydroxytyrosol | 0.01 |
| Esterin (alfalfa extract) | 0.20 |
| | 100.00 |

### REFERENCES

[1] Grignaffini P., Roma P., Galli C., Catapano A. L.; “Protection of low-density lipoprotein from oxidation by 3,4 dihydroxyphenylethanol”; Lancet, 343, 1296-1297 (1994).
[2] Salami M., Galli C., De Angelis L., Visioli F.; “Formation of F2-isoprostanes in oxidized low density lipoprotein: inhibitory effect of hydroxytyrosol”; Pharmacol Res, 31, 275-279 (1995).
[3] Petroni A., Blasevich M., Salami M., Papini N., Montedoro G. F., Galli C.; “Inhibition of platelet aggregation and eicosanoid production by phenolic components of olive oil”; Thromb Res, 78, 151-160 (1995).
[4] De la Puerta R., Ruiz Gutierrez V., Hoult R. S.; “Inhibition of leukocyte 5-lipoxygenase by phenolics from virgin olive oil”; Biochem Pharmacol, 57, 445-449 (1999).
[5] Manna C., Galletti P., Cucciola V., Moltedo 0., Leone A., Zappia V.; “The protective effect of the olive oil polyphenol (3,4-dihydroxyphenyl) ethanol counteracts reactive oxygen metabolite-induced cytotoxicity in Caco-2 cells”; J Nutr, 127, 286-292 (1997).
[6] Manna C., Galletti P., Cucciola V., Montedoro G., Zappia V.; “Olive oil hydroxytyrosol protects human erythrocytes against oxidative damages”; J Nutr Biochem, 10, 159-165 (1999).
[7] Manna C., Galletti P., Misto G., Cucciola V., D′Angelo S., Zappia V.; “Transport mechanism and metabolism of olive oil hydroxytyrosol in Caco-2”; FEBS lett, 31, 341-344 (2000).
[8] D'Angelo S., Manna C., Migliardi V., Mazzoni O., Morsica P., Capasso G., Pontoni G., Galletti P., Zappia V.; “Pharmacokinetics and metabolism of hydroxytyrosol, a natural antioxidant from olive oil”; DMD, 29, 1492-1498 (2001).
[9] Sanchez-Moreno C., Larrauri J. A., Saura-Calixto F.; “A procedure to measure the antiradical efficiency of polyphenols”; J Sci Food Agric, 76, 270-276 (1998).
[10] Carluccio M. A., Siculella L., Ancora M. A., Massaro M., Scoditti E., Storelli C., Visioli F., Distante A., De Caterina R.; “Olive oil and red wine antioxidant polyphenols inhibit endothelial activation: antiatherogenic properties of Mediterranean diet phytochemicals”; Arterioscler Thromb Vasc Biol. 23, 622-9 (2003).
[11] Fabiani R., De Bartolomeo A., Rosignoli P., Servili M., Montedoro G. F., Morozzi G.; “Cancer chemoprevention by hydroxytyrosol isolated from virgin olive oil through G1 cell cycle arrest and apoptosis”; Eur J Cancer Prev. Aug;11(4):351-8 (2002).
[12] Ancora P., Rona C., Pavanetto F., Troisi L., Villanova L., Perugini P.; “Valutazione di Efficacia di Formulazioni Cosmetiche a base di Oleuropeina”; Proceedings of “Congresso Nazionale di Medicina Estetica”, Rome, 24-26 April 2004.
Ancora M. A., Carluccio M. A., Massaro M., Storelli C., Villanova L.; “Selective Pro-Apoptotic Effects of the Mediterranean Diet Antioxidant Hydroxytyrosol”; Proceedings of “XVII Congresso Nazionale—Societa Italiana per lo Studio dell'Aterosclerosi”, Naples 26-29 November 2003.
[14] Visioli F., Galli C., Plasmati E., Viappiani S., Hernandez A., Colombo C., Sala A.; “Olive phenol hydroxytyrosol prevents passive smoking-induced oxidative stress”; Circulation, 2000, 102, 2169-2173.

1-8. (canceled)

9. Yoghurt containing hydroxytyrosol.

10. Yoghurt as claimed in claim 9, containing hydroxytyrosol in percentages ranging between 10 and 0.0001%.

11. Yoghurt as claimed in claim 9, containing hydroxytyrosol in percentages ranging between 0.1 and 0.01%.

12. Yoghurt containing hydroxytyrosol with other biophenols.

13. Yoghurt as claimed in claim 12, containing hydroxytyrosol with other biophenols, each in percentages ranging between 10 and 0.0001%.

14. Yoghurt as claimed in claim 9, containing hydroxytyrosol with other biophenols, each in percentages ranging between 0.1 and 0.01%.

15. Yoghurt as claimed in claim 9, characterised by the maintenance of its organoleptic properties, HT activity, activity of other biophenols, and stability for at least three months.

16. Yoghurt as claimed in claim 9, also containing ingredients typically added to traditional yoghurts, selected from whole fruit or fruit chunks, cereals, vegetable fibres, honey, chocolate chips, flavourings and the like.

17. Yoghurt as claimed in claim 12 comprising basic yoghurt 99.67%, hydroxytyrosol 0.01%, caffeic acid 0.01% and gallic acid 0.01%.
